(19) United States
(12) Patent Application Publication
(10) Pub. No.: US 2015/0019794 A1
(43) Pub. Date: Jan. 15, 2015

(54) DATA STORAGE DEVICE AND OPERATING METHOD THEREOF

(71) Applicant: SK hynix Inc., Gyeonggi-do (KR)

(72) Inventor: Eu Joon BYUN, Gyeonggi-do (KR)

(73) Assignee: SK hynix Inc., Gyeonggi-do (KR)

(21) Appl. No.: 14/038,281

(22) Filed: Sep. 26, 2013

(30) Foreign Application Priority Data
Jul. 9, 2013 (KR) 10-2013-0080211

(51) Int. Cl. G06F 3/06

(52) U.S. Cl. CPC G06F 3/0611; G06F 3/0679; G06F 3/0655
USPC 711/103

(57) ABSTRACT

A data storage device and a method of operating the same. The data storage device includes a nonvolatile memory device and a working memory device. The working memory device is configured to store an address mapping table to map a physical address associated with the nonvolatile memory device to a logical address associated with a host device. The data storage device further includes a controller configured to identify a hot address mapping table from a plurality of address mapping tables, based on an address mapping table classification, and store the hot address mapping table into the working memory device at an operation start time of the data storage device.

### CROSS-REFERENCES TO RELATED APPLICATION

The present application claims priority under 35 U.S.C. §119(a) to Korean application number 10-2013-0080211, filed on Jul. 9, 2013, in the Korean intellectual Property Office, which is incorporated herein by reference in its entirety.

### BACKGROUND

1. Technical Field

Various implementations relate to a data storage device, and more particularly, to an operating method for improving performance of a data storage device.

2. Related Art

The recent paradigm for computer surroundings has changed to a ubiquitous computing environment in which computer systems may be used anytime and anywhere. Thus, the use of portable electronic devices, such as mobile phones, digital cameras, and notebook computers has rapidly increased. Such portable electronic devices use a data storage device using a memory device.

Since the data storage device using a memory device has no mechanical driver, the data storage device provides the advantages of improved stability and durability, high access speed, and small power consumption. The data storage device may include a universal serial bus (USB) memory device, a memory card having various interfaces, or a solid state drive (SSD).

A host device to access the data storage device provides a logical address to the data storage device. The data storage device converts the provided logical address into a physical address of the data storage device, and performs a requested operation based on the converted physical address. For the address conversion operation, the data storage device may manage an address mapping table.

### SUMMARY

Various implementations are directed to an operating method or improving performance of a data storage device.

A method of operating an exemplary data storage device includes identifying, via the controller, a hot address mapping table from a plurality of address mapping tables, based on an address mapping table classification standard; and storing the hot address mapping table into a working memory device at an operation start time of the data storage device.

An exemplary data storage device includes a nonvolatile memory device; a working memory device configured to store an address mapping table to map a physical address associated with the nonvolatile memory device to a logical address associated with a host device; and a controller configured to identify a hot address mapping table from a plurality of address mapping tables, based on an address mapping table classification, and store the hot address mapping table into the working memory device at an operation start time of the data storage device.

### BRIEF DESCRIPTION OF THE DRAWINGS

Features, aspects, and implementations are described in conjunction with the attached drawings, in which:

FIG. 1 is a block diagram illustrating a data processing system including an exemplary data storage device;

FIG. 2 is a flowchart explaining an operating method of the exemplary data storage;

FIG. 3 is an exemplary address mapping table explaining a method for managing a hot address mapping table;

FIG. 4 is an exemplary address mapping table explaining a method for preloading a hot address mapping table according to the implementation of the present invention;

FIG. 5 is a block diagram illustrating an exemplary data processing system;

FIG. 6 is a block diagram illustrating an exemplary solid state drive (SSD);

FIG. 7 is a block diagram illustrating an exemplary controller for the SSD controller of FIG. 6; and

FIG. 8 is a block diagram illustrating a computer system in which an exemplary data storage device is mounted.

### DETAILED DESCRIPTION

Exemplary implementations of the present invention will be described below in more detail with reference to the accompanying drawings. The present invention may, however, be embodied in different forms and should not be construed as limited to the exemplary implementations set forth herein. Rather, these exemplary implementations are provided so that this disclosure will be thorough and complete, and will fully convey the scope of the present invention to those skilled in the art.

The drawings are not necessarily to scale and in some instances, proportions may have been exaggerated in order to clearly illustrate features of the exemplary implementations. In this specification, specific terms have been used. The terms are used to describe the exemplary implementations of the present invention, and are not used to qualify the sense or limit the scope of the present invention.

In this specification, “and/or” represents that one or more of components arranged before and after “and/or” is included. Furthermore, “connected/coupled” represents that one component is directly coupled to another component or indirectly coupled through another component. In this specification, a singular form may include a plural form as long as it is not specifically mentioned in a sentence. Furthermore, “include/comprise” or “including/comprising” used in the specification represents that one or more components, steps, operations, or elements may exist or may be added.

Hereafter, the exemplary implementations of the present invention will be described with reference to the drawings.

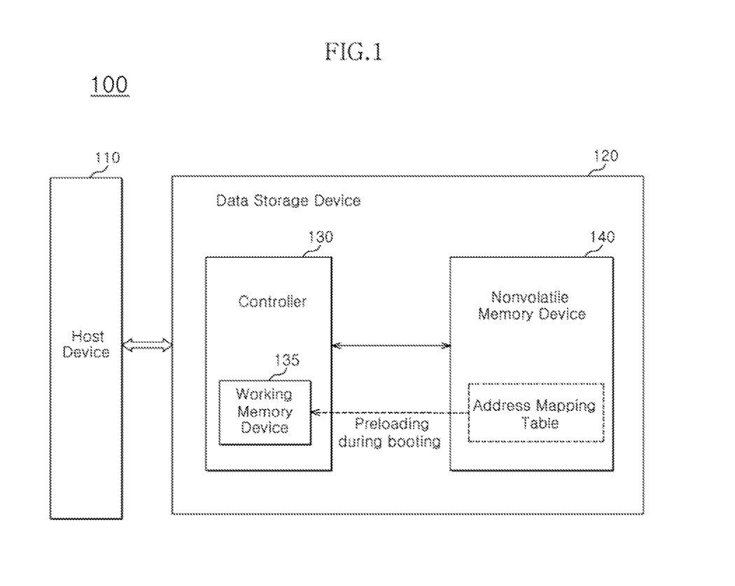

FIG. 1 is a block diagram illustrating an exemplary data processing system. Referring to FIG. 1, the data processing system 100 may include a host device 110 and a data storage device 120.

For example, the host device 110 may include a portable electronic device, such as a mobile phone, a tablet computer, or an MP3 player, or an electronic device, such as a lap-top computer, a desktop computer, a game machine, a television, or a projector.

The data storage device 120 may operate in response to a request of the host device 110. The data storage device 120 may store data accessed by the host device 110. That is, the data storage device 120 may be used as an auxiliary memory device of the host device 110. The data storage device 120 is referred to as a memory system.

The data storage device 120 may include a controller 130 and a nonvolatile memory device 140. The controller 130 and the nonvolatile memory device 140 may be implemented with a memory device that may be connected to the host device 110 through various interfaces. Alternatively, the controller 130 and the nonvolatile memory device 140 may be implemented with a solid state drive (SSD).

The controller 130 may control overall operations of the data storage device 120 The controller 130 may drive firmware (or software) to control an overall operation of the data storage device 120. The firmware (or software) and data required for driving the firmware (or software) may be stored in a working memory device 135. The controller 130 may be implemented in a hardware or a combination of a hardware and a software.

The working memory device 135 may store firmware (or software) and data required for the operation of the controller 130. The working memory device 135 may temporarily store data to be communicated to the nonvolatile memory device 140 from the host device 110 or to be communicated to the host device 110 from the nonvolatile memory device 140. That is, the working memory device 135 may operate as a buffer memory device or cache memory device. FIG. 1 shows that the working memory device is part of the controller

The controller 130 may control the nonvolatile memory device in response to a request from the host device 110. For example, the controller 130 may provide data read from the nonvolatile memory device 140 to the host device 110. In an alternative exemplary implementation, the controller 130 may store data provided from the host device 110 in the nonvolatile memory device 140. For this operation, the controller 130 may control a read operation, a program (or a write), operation, or an erase operation of the nonvolatile memory device 140.

The nonvolatile memory device 140 may performs a read operation or a program operation on a page due to structural characteristics thereof. The nonvolatile memory device 140 may perform an erase operation on a block due to the structural characteristics thereof. Furthermore, the nonvolatile memory device 140 cannot perform an overwrite operation due to the structural characteristics thereof. That is, a memory cell of the nonvolatile memory device 140 must be erased to store new data. Since the nonvolatile memory device 140 has these characteristics, the controller 130 may drive additional firmware referred to as a flash translation layer (FTL).

The FTL may manage a read operation, a program operation, or an erase operation of the nonvolatile memory device 140 so that the data storage device 120 may operate in response to an access (for example, read or write operation) request from a file system of the host device 110. Furthermore, the FTL may manage an additional operation based on the characteristics of the nonvolatile memory device 140. For example, the FTL may manage a garbage collection operation, a wear-leveling operation, or a bad block management operation.

When the host device 110 accesses the data storage device 120 (for example, if a read operation or a write operation is requested), the host device 110 may provide a logical address to the data storage device 120. The controller 130 may convert the provided logical address into a physical address associated with the nonvolatile memory device 140, and may perform the requested operation by referring to the converted physical address. For this address conversion operation, address conversion data, such as an address mapping table is needed. The address mapping table may be managed by the FTL.

While the data storage device 120 is driven, the address mapping table may be loaded into the working memory device 135. Since the address mapping table contains information required to driving the data storage device 120, the address mapping table may be backed up into the nonvolatile memory device 140 from the working memory device 135. The backup operation for the address mapping table may be performed at a time at which a backup is required or at a time at which an operation of the data storage device 120 is ended (or powered off).

The address mapping table that is backed up into the nonvolatile memory device 140 may be loaded from the nonvolatile memory device 140 into the working memory device 135 at a necessary time or at an operation start time of the data storage device 120. According to an exemplary implementation, a part of the address mapping table may be preloaded into the working memory device 135 at the operation start time of the data storage device 120. The preloaded address mapping table is highly likely to be used after the data storage device 120 is booted. That is, the preloaded address mapping table may be frequently referred to for address mapping after the data storage device 120 is booted.

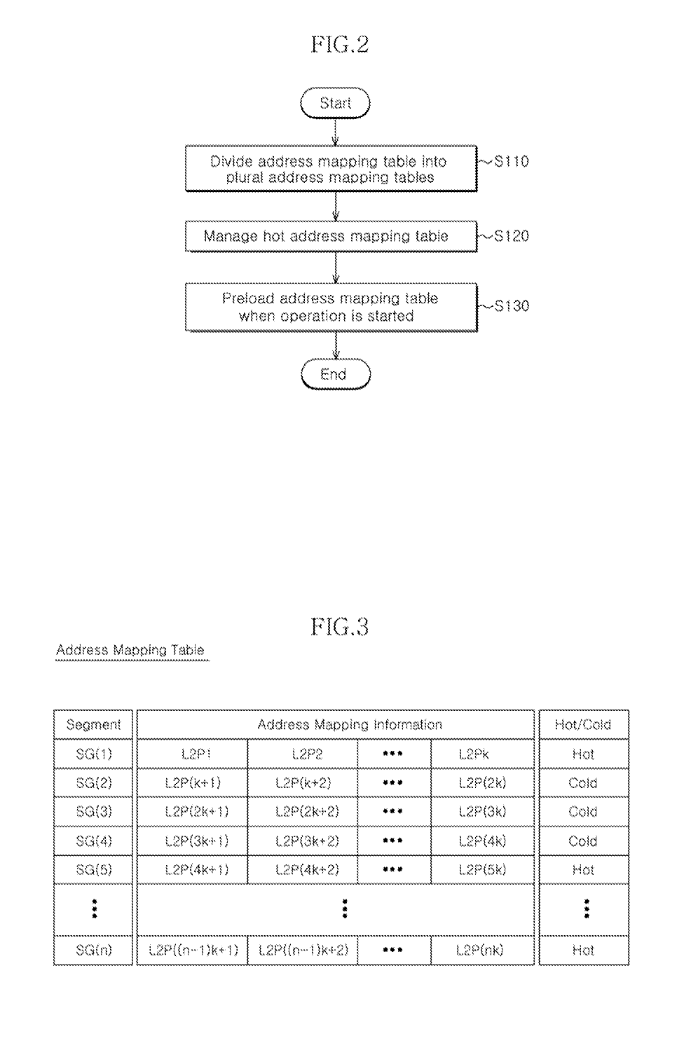

FIG. 2 is a flowchart for explaining an operating method of the data storage device according to an exemplary implementation. Referring to FIG. 2, the controller 130 may divide the address mapping table into a plurality of address mapping tables at step S110. The controller 130 may identify a hot address mapping table from among the divided address mapping tables at step S120 and may manage the hot address mapping table. When, the operation of the data storage device 120 is started, the controller 130 preloads the hot address mapping table into the working memory device at step S130. The controller 130 may identify an operation start time as a time at which the data storage device 120 changes from a power-off state to a power-on state or a time at which the data storage device 120 changes from a power-saving state to a normal state.

The controller 130 identifies each of the divided address mapping tables as a hot address mapping table or a cold address-mapping table, based on an address mapping table classification standard. The controller 130 may manage one or more of the divided address mapping tables as a hot address mapping table(s).

For example, the address mapping table classification standard used by the controller 130 may be information regarding whether or not an address mapping table is loaded into the working memory device 135 at the operation end time of the data storage device 120. In this case, when the address mapping table is loaded into the working memory device 135 at the operation end time of the data storage device 120, the controller identifies the address mapping table as a hot address mapping table. Furthermore, if the address mapping table is not loaded into the working memory device 135 at the operation end time of the data storage device 120, then the controller identifies the address mapping table as a the cold address mapping table. The controller 130 may identify an operation end time as a time at which the data storage device 120 changes from a power-on state to a power-off state or a time at which the data storage device 120 changes from a normal state to a power saving state.

Alternatively, the controller 130 may use information on how many times an address mapping table is referred to the controller 130 during the operation of the data storage device 120, as the address mapping table classification standard. In this case, the hot address mapping table indicates an address mapping table that is referred to at a higher frequency than a reference frequency. Alternatively, the hot address mapping table indicates an address mapping table that has the highest reference number [Unclear. There is no description of what “reference number” means.] among the address mapping tables. Alternatively, the hot address mapping table indicates an address mapping table that is referred to more frequently than other address mapping tables. Furthermore, the cold address mapping table indicates an address mapping table that is referred to at a lower frequency than the reference frequency. Alternatively, the cold address mapping table indicates an address mapping table that has the lowest reference number among the address mapping tables. Alternatively, the cold address mapping table indicates an address mapping table that is referred to less frequently than other address mapping tables.

The cold address mapping table may include an address mapping table that is less likely to be used after the data storage device 120 is booted, that is, which will be referred to for address mapping at a low frequency. On the other hand, the hot address mapping table may include an address mapping table that is highly likely to be used after the data storage device 120 is booted, that is, which will be referred to for address mapping at a high frequency. Therefore, the hot address mapping table is preloaded into the working memory device when the operation of the data storage device 120 is started.

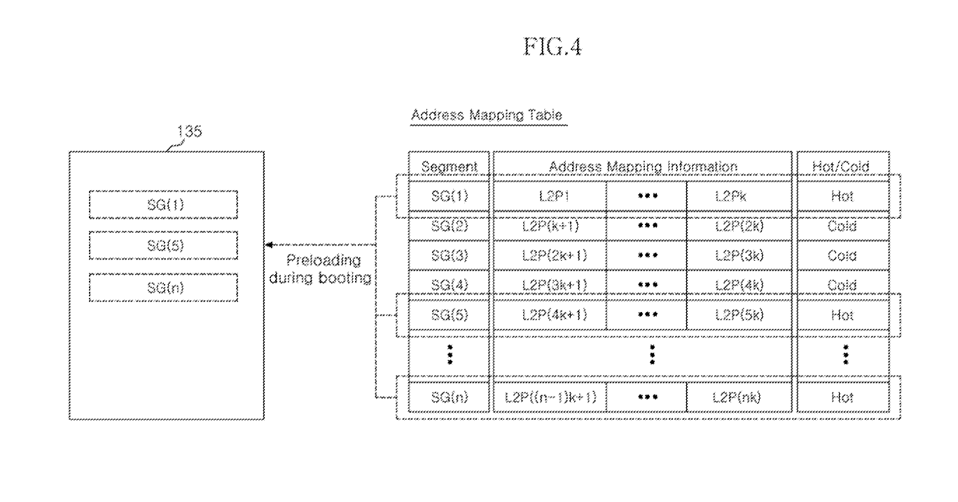

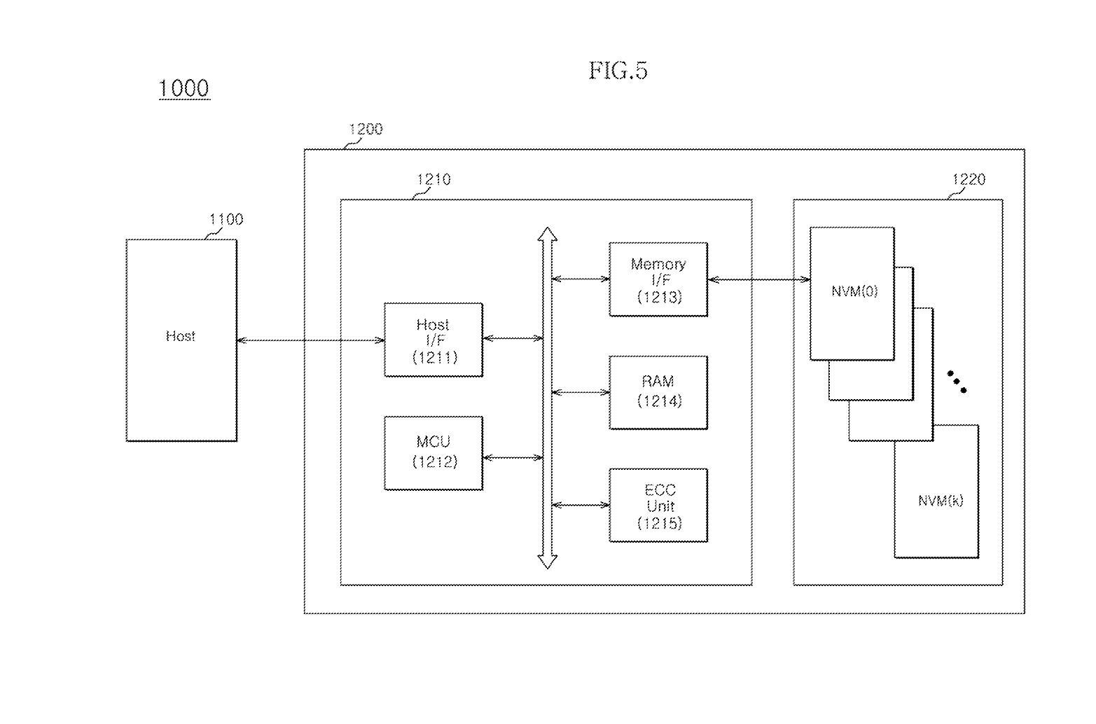

FIG. 3 is an address mapping table for explaining a method of managing a hot address mapping table according to the implementation of the present invention. FIG. 4 is an address mapping table for explaining a method for preloading a hot address mapping table according to the implementation of the present invention.

An address mapping table may divided into a plurality of address mapping table segments SG. The address mapping table is loaded into the working memory device 135 by the segment. The number of address mapping table segments loaded into the working memory device 135 may be varied depending on the storage space of the working memory device.

Each of the address mapping table segments may include physical address information L2P, associated with the nonvolatile memory device 140, that corresponds to a logical address of the host device 110. For example, as illustrated in FIG. 3, each of the address mapping table segments may include k pieces of physical address information L2P that correspond to a logical address of the host device 110

As described with reference to FIG. 2, each of the address mapping table segments SG may be identified as a hot address mapping table or cold address mapping table based on the address mapping table classification standard. Classification information indicating whether the address mapping table segment SG is a hot address mapping table or cold address mapping table may associated with the address mapping table segment SG in the form of index, flag, or tag for each of the address mapping table segments SG. FIG. 3 illustrates that address mapping table segments SG(1), SG(5), and SG(n) are classified as hot address mapping tables.

According to an exemplary implementation, the address mapping table segments SG that: classified as the hot address mapping tables are preloaded into the working memory device 135 at the operation start time of the data storage device 120 (power on or booting). For example, as illustrated in FIG. 4, the address mapping table segments SG(1), SG(5), and SG(n), which are classified as hot address mapping, tables may be loaded into the working memory device 135 at the operation start time of the data storage device 120.

FIG. 5 is a block diagram illustrating an alternative exemplary data processing system. Referring to FIG. 5, the data processing system 1000 may include a host device 1100 and a data storage device 1200. The data storage device 1200 may include a controller 1210 and a nonvolatile memory device 1220. The data storage device 1200 may be connected to a host device 1100, such as, for example, a desktop computer, a notebook computer, a mobile phone, an MP3 player, or a game machine. The data storage device 1200 is also referred to as a memory system.

The data storage device 1200 may perform an address mapping table preloading operation at an operation start time of the data storage device 1200. Thus, the performance of the data storage device 1200 may be improved.

The controller 1210 may access the nonvolatile memory device 1220 in response to a request from the host device 1100. For example, the controller 1210 may control a read operation, a program operation, or an erase operation of the nonvolatile memory device 1220. The controller 1210 may drive firmware for controlling the nonvolatile memory device 1220.

The controller 1210 may include a host interface 1211, a micro-control unit 1212, a memory interface 1213, a RAM, or an error correction code (ECC) unit 1215.

The micro-control unit 1212 may control overall operations of the controller 1210 in response to a request of the host device. The RAM 1214 may be used as a working memory of the micro-control unit 1212. The RAM 1214 may temporarily store data read from the nonvolatile memory device 1220 or data provided from the host device 1100.

The host interface 1211 may interface the host device 1100 and the controller 1210. For example, the host interface 1211 may communicate with the host 1100 through an interface protocol, such as a USB (Universal Serial Bus) protocol, a MC (Multimedia Card) protocol, a PCI (Peripheral Component Interconnection) protocol, a PCI-E (PCI-Express) protocol, a PATA (Parallel Advanced Technology Attachment) protocol, a SATA (Serial ATA) protocol, an SCSI (Small Computer System Interface) protocol, a SAS (Serial Attached SCSI) protocol, or an IDE (Integrated Drive Electronics) protocol.

The memory interface 1213 may interface the controller 1210 and the nonvolatile memory device 1220. The memory interface 1213 may provide a command and address to the nonvolatile memory device 1220 for controlling the nonvolatile memory device 1220. Furthermore, the memory interface 1213 may exchange data with the nonvolatile memory device 1220.

The ECC unit 1215 may detect an error in the data read from the nonvolatile memory device 1220. Furthermore, the ECC unit 1215 may correct the detected error, when the detected error falls within a correction range. The ECC unit 1215 may be provided inside or outside the controller 1210, depending on the memory system 1000.

The controller 1210 and the nonvolatile memory device 1220 may be integrated into one semiconductor device to form a memory device. For example, the controller 1210 and the nonvolatile memory device 1220 may be integrated into one semiconductor device to form, for example, a PCMCIA (personal computer memory card international association) card, a CF (compact flash) card, a smart media card, a memory stick, a multi-media card (MMC, RS-MMC, or MMC-micro), an SD (secure digital) card (SD, Mini-SD, or Micro-SD), or a UFS (universal flash storage) card.

Alternatively, the controller 1210, or the nonvolatile memory device 1220, may be packaged and mounted as discrete packages. For example, the controller 1210, or the data storage medium 1220, may be packaged and mounted according to a method, such as, for example, a POP package on package (POP), a ball grid array (BGA), a chip scale package (CSP), a plastic leaded chip carrier (PLCC), a plastic dual in-line package (DIP), a die in waffle pack, a die in wafer form, a chip on board (COB), a ceramic dual in-line package (CERDIP), a plastic metric quad flat package (QFP), a thin quad flat package (TQFP), a small outline IC (SOIC), a shrink small outline package (SSOP), a thin small outline package (TSOP), a thin quad flat package (TQFP), a system in package (SIP), a multi chip package (MCP), a wafer-level fabricated package (WFP), or a wafer-level processed stack package (WSP).

The nonvolatile memory device 1220 may include a plurality of the nonvolatile memory devices NVM(0) to NVM(k).

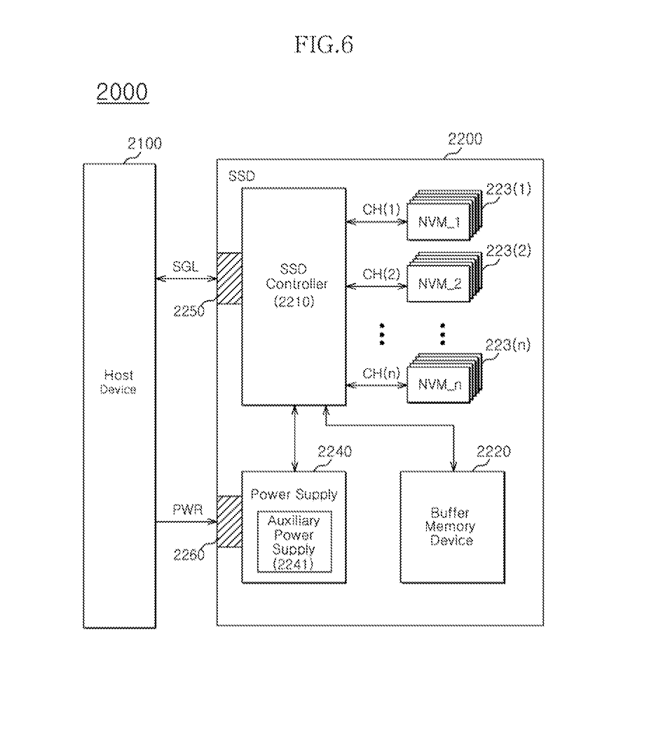

FIG. 6 is a block diagram illustrating an exemplary solid state drive (SSD). Referring to FIG. 6, a data processing system 2000 may include a host device 2100 and an SSD 2200.

The SSD 2200 may include an SSD controller 2210, a buffer memory device 2220, a plurality of nonvolatile memory devices 2231 to 223n, a power supply 2240, a signal connector 2250, and a power connector 2260.

The SSD 2200 operates in response to a request from the host device 2100. That is, the SSD controller 2210 may access the nonvolatile memory devices 2231 to 223n in response to a request from the host device 2100. For example, the SSD controller 2210 may control a read operation, a program operation, or an erase operation of the nonvolatile memory devices 2231 to 223n. Furthermore, the exemplary SSD controller 2210 may perform an address mapping table preloading at the operation start time of the SSD 2200. Thus, the performance of the SSD 2200 may be improved.

The buffer memory device 2220 is configured to temporarily store data which are to be stored in the nonvolatile memory devices 223(1) to 223(n). Furthermore, the buffer memory device 2220 is configured to temporarily store data read from the nonvolatile memory devices 223(1) to 223(n). The data temporarily stored in the buffer memory device 2220 are communicated to the host device 2100 or the nonvolatile memory devices 223(1) to 223(n), according to the control of the SSD controller 2210.

The nonvolatile memory devices 2231 to 223n may be used as storage media of the SSD 2200. The nonvolatile memory devices 223(1) to 223(n) are connected to the SSD controller 2210 through a plurality of corresponding channels CH(1) to CH(n). A single channel, of the plurality of channels, may be connected to one or more of the nonvolatile memory devices. Nonvolatile memory devices that are connected to the single channel may be connected to the same signal bus and data bus.

The power supply 2240 may provide power PWR inputted through the power connector 2260 into the SSD 2200. The power supply 2240 may include an auxiliary power supply 2241. The auxiliary power supply 2241 may supply power to the SSD 2200 for normally terminating, if a sudden power off occurs. The auxiliary power supply 2241 may include a super capacitor to store the power PWR.

The SSD controller 2210 may exchange signals SGL with the host device 2100 through the signal connector 2250. The signals SGL may include commands, addresses data, or any other signal that may be necessary for the operation of the SSD. The signal connector 2250 may include a connector, such as a PATA (Parallel Advanced Technology Attachment), a SATA (Serial Advanced Technology Attachment), a SCSI (Small Computer System Interface), or a SAS (Serial Attached SCSI), based on the interface method between the host device 2100 and the SSD 2200.

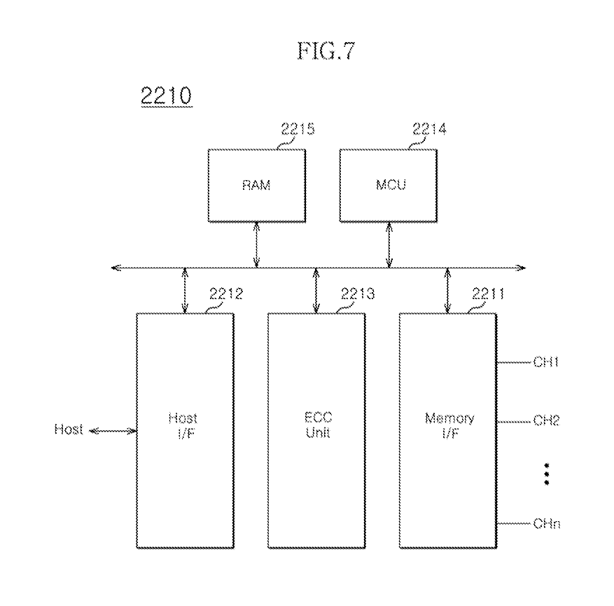

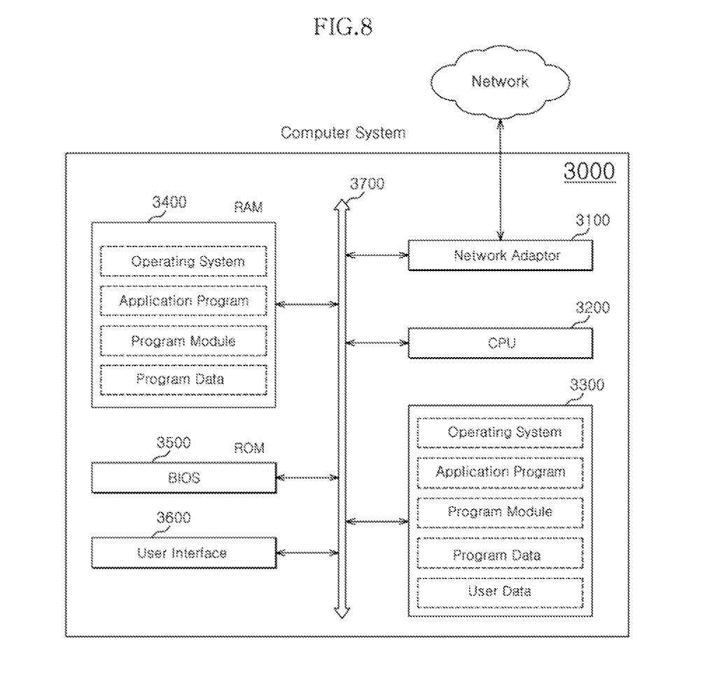

FIG. 7 is a block diagram illustrating the exemplary SSD controller of FIG. 6. Referring to FIG. 7, the SSD controller 2210 may include a memory interface 2211, a host interface 2212, an ECC unit 2213, a micro-control unit 2214, or a RAM 2215.

The memory interface 2211 may provide a command and an address to the nonvolatile memory devices 223(1) to 223(n). Furthermore, the memory interface 2211 may exchange data with the nonvolatile memory devices 223(1) to 223(n). The memory interface 2211 may provided data, communicated from the buffer memory device 2220, over the channels CH(1) to CH(n), based on a control signal from the micro-control unit 2214. Furthermore, the memory interface 2211 communicates data read from the nonvolatile memory devices 223(1) to 223(n) to the buffer memory device 2220, based on a control signal from the micro-control unit 2214.

The host interface 2212 is configured to interface the SSD 2200 in response to the protocol of the host device 2100. For example, the host interface 2212 may be configured to communicate with the host device 2100 through a PATA (Parallel Advanced Technology Attachment) protocol, a SATA (Serial Advanced Technology Attachment) protocol, a SCSI (Small Computer System Interface) protocol, or a SAS (Serial Attached SCSI) protocol. Furthermore, the host interface 2212 may perform a disk emulation function of supporting the host device 2100 to recognize the SSD 2200 as a hard disk drive (HDD).

The ECC unit 2213 is configured to generate parity bits based on the data communicated to the nonvolatile memory devices 223(1) to 223(n). The generated parity bits may be stored in spare areas of the nonvolatile memory devices 223(1) to 223(n). The ECC unit 2213 is configured to detect an error of data read from the nonvolatile memory devices 2231 to 223n. When the detected error falls within a correction range, the ECC unit 2213 may correct the detected error.

The micro-control unit 2214 is configured to analyze and process a signal SGL inputted from the host device 2100. The micro-control unit 2214 controls overall operations of the SSD controller 2210 in response to a request of the host device 2100. The micro-control unit 2214 controls the operations of the buffer memory device 2220 and the nonvolatile memory devices 2231 to 223n according to firmware for driving the SSD 2200. The RAM 2215 is used as a working memory device for driving the firmware.

FIG. 8 is a block diagram illustrating an exemplary computer system in which an exemplary data storage device is mounted. Referring to FIG. 8, the computer system 3000 may include a network adapter 3100, a CPU 3200, a data storage device 3300, a RAM 3400, a ROM 3500, or a user interface 3600, which are electrically connected to the system bus 3700. The data storage device 3300 may include the exemplary data storage device 120 illustrated in FIG. 1, the exemplary data storage device 1200 illustrated in FIG. 5, or the exemplary SSD 3200 illustrated in FIG. 6.

The network adapter 3100 may provide an interface between the computer system 3000 and external networks. The CPU 3200 may include any type of processor or microprocessor that interprets and executes instructions. In some implementations, processing logic 220 may be implemented as or include an application specific integrated circuit (ASIC), field programmable gate array (FPGA), or the like.

The data storage device 3300 may store data required for the operation of the computer system 3000. For example, the operating system for running the computer system 3000, application programs, various program modules, program data, or user data may be stored in the data storage device 3300. The RAM 3400 may include a RAM device or other type of dynamic storage device that stores information and instructions for execution by the computer system 3000. For example, during booting of the computer system 3000, the operating system, application programs, various program modules, which are read from the data storage device 3300, and program data required for running the programs are loaded into the RAM 3400. The ROM 3500 may include a ROM device or other type of static storage device that stores static information and instructions for execution by the computer system 3000. For example, the ROM 3500 may store a basic input/output system (BIOS) that is enabled before the operating system is run. The user interface 3600 may 260 may include a device that permits a user to input information to the computer system 3000, such as a keyboard, a keypad, a mouse, a pen, a microphone, one or more biometric mechanisms, or the like.

Although not illustrated in the drawing, the computer system 3000 may further include a battery, application chipsets, a camera image processor (UP), or the like.

While certain implementations have been described above, it will be understood to those skilled in the art that the implementations described are by way of example only. Accordingly, the data storage device described herein should not be limited based on the described implementations. Rather, the data storage device described herein should only be limited in light of the claims that follow when taken in conjunction with the above description and accompanying drawings.

What is claimed is:

1. A method of operating a data storage device, the method comprising
identifying, via the controller, a hot address mapping table from a plurality of address mapping tables, based on an address mapping table classification standard; and
storing the hot address mapping table into a working memory device at an operation start time of the data storage device.

2. The method of claim 1, wherein the address mapping table classification standard includes information regarding whether an address mapping table is stored in the memory device at an operation end time of the data storage device.

3. The method of claim 2, wherein identifying a hot address mapping table from the plurality of address tables, based on an address mapping table classification standard further comprises:
identifying an address mapping table that is stored in the working memory device at the operation end time of the data storage, as the hot address mapping table.

4. The method of claim 2, wherein the operation end time is a time at which the data storage device changes to a power-off state or power saving state.

5. The method of claim 1, wherein the address mapping table classification standard includes information regarding a number of times an address mapping table, of the plurality of address mapping tables, is referred to during an operation of the data storage device.

6. The method of claim 5, wherein identifying a hot address mapping table from the plurality of address tables, based on an address mapping table classification standard further comprises:
identifying, as the hot address mapping table, an address mapping table, of the plurality of address mapping tables, that is referred to the controller at a frequency that is greater than a reference frequency.

7. The method of claim 5, wherein identifying a hot address mapping table from the plurality of address tables, based on an address mapping table classification standard further comprises:
identifying, as the hot address mapping table, an address mapping table, of the plurality of address mapping tables, having a highest reference number.

8. The method of claim 1, further comprising dividing the plurality of address mapping tables into a plurality of segments, each including a physical address, associated with a nonvolatile memory device, that corresponds to a logical address of a host device that is in communication with the nonvolatile memory device.

9. The method of claim 8, further comprising:
identifying a segment, of the plurality of segments, as the hot address mapping table by associating an index, a flag, or a tag with the segment.

10. The method according to claim 1, wherein the operation start time is a time at which the data storage device changes from a power-off state to a power-on state or changes from a power saving state to a normal state.

11. A data storage device comprising:
a nonvolatile memory device;
a working memory device configured to store an address mapping table to map a physical address associated with the nonvolatile memory device to a logical address associated with a host device; and
a controller configured to:
identify a hot address mapping table from a plurality of address mapping tables, based on an address mapping table classification, and
store the hot address mapping table into the working memory device at an operation start time of the data storage device.

12. The data storage device of claim 11, wherein the address mapping table classification standard includes information regarding whether an address mapping table, of the plurality of address mapping tables, is stored in the working memory device at an operation end time of the data storage device.

13. The data storage device of claim 12, wherein, when the controller is to identify a hot address mapping table from the plurality of address mapping tables, the controller further is to:
identify, as the hot address mapping table, an address mapping table, of the plurality of address mapping tables, that is stored in the working memory device at the operation end time of the data storage device.

14. The data storage device of claim 12, wherein the operation end time is a time at which the data storage device changes to a power-off state or power saving state,

15. The data storage device of claim 11, wherein the address mapping table classification standard includes information regarding a number of times an address mapping table, of the plurality of address mapping tables, is referred to during an operation of the data storage device.

16. The data storage device of claim 15, wherein, when the controller is to identify a hot address mapping table from the plurality of address mapping tables, the controller further is to:
identify, as the hot address mapping table, an address mapping table, of the plurality of address mapping tables, that is referred to the controller at a frequency that is greater than a reference frequency.

17. The data storage device of claim 15, wherein, when the controller is to identify a hot address mapping table from the plurality of address mapping tables, the controller further is to:
identify, as the hot address mapping table, an address mapping table, of the plurality of address mapping, tables, having the highest reference number.

18. The data storage device of claim 1, wherein the controller further is to:
divide the plurality of address mapping tables into a plurality of segments, each including a physical address, associated with the nonvolatile memory device, that corresponds to a logical address of a host device that is in communication with the nonvolatile memory device.

19. The data storage device of claim 18, wherein the controller further is to:
identify a segment, of the plurality of segments, as the hot address mapping table by associating an index, a flag, or a tag with the segment.

20. The data storage device according to claim 11, wherein the operation start time is a time at which the data storage device changes from a power-off state to a power-on state or changes from a power saving state to a normal state.
